(19) United States
(12) Patent Application Publication
(10) Pub. No.: US 2006/0251564 A1
(43) Pub. Date: Nov. 9, 2006

(54) Carbon nanomaterial purification method

(75) Inventors: Kon-Tsu Kin, Taipei City (TW); Chiou-Mei Chen, Hsinchu City (TW); Ching-Yi Hsu, Kaohsiung City (TW)

Correspondence Address: BIRCH STEWART KOLASCH & BIRCH, PO BOX 747, FALLS CHURCH, VA, 22040-0747, US

(73) Assignee: Industrial Technology Research Institute

(21) Appl. No.: 11/274,325

(22) Filed: Nov. 16, 2005

(30) Foreign Application Priority Data
Dec. 31, 2004 (TW) 93141725

(51) Int. Cl. C01B 31/02

(52) U.S. Cl. 423/445 B

(57) ABSTRACT

A method for purifying carbon nanomaterial. This method comprises providing a carbon nanomaterial or a device substrate having a carbon nanomaterial. The carbon nanomaterial or the device substrate having a carbon nanomaterial is placed in a chamber. Ozone is introduced into the chamber at room temperature and atmospheric pressure to oxidize and remove impurities from the carbon nanomaterial.

### BACKGROUND

The invention relates to carbon nanomaterial and in particular to a method for purifying carbon nanomaterial.

In 1991, S. Ijinma of NEC corp. in Japan discovered 1˜30 nm needle during C60 synthesis by arc-discharge method. This needle is a hollow tube made of carbon atoms, referred to as a carbon nanotube. This carbon nanotube provides good thermal conductivity, electric conductivity, physical and mechanical characteristics, stable chemical characteristics, increased hardness and elasticity, all thus can be used in many applications, such as field emission display plane, hydrogen storage media, microprobe, microelectrode, trace chemical detector, complex material intensifier.

Carbon nanotubes are usually formed by laser ablation, arc-discharge or chemical vapor deposition (CVD), all of which require carbon source and catalyst at high temperature or high voltage. Most carbon nanotubes comprise many impurities such as catalyst particles, amorphous carbon, graphite particles, coal ash and non-tube carbons, as well as using specific method related can terminated, such as CVD, adding catalyst. Thus, the carbon nanotube product must be purified to obtain high purity carbon nanotubes.

To remove impurities, a method for purifying carbon nanotube is disclosed in U.S. Pat. No. 6,683,783. This method removes amorphous carbon by hot oxidizing solution, such as nitric acid, hydrogen peroxide or sulfuric acid mixture or potassium permanganate solution. Another method for purifying carbon nanotube is disclosed in U.S. Pat. No. 5,641,466, in which impurities are removed by use of an oxidizing gas. This oxidizing gas, such as air, oxygen or ozone, is heated to 600˜1000° C. Furthermore, other carbon nanotube purifying methods are disclosed in U.S. Pat. Nos. 5,698,175, 6,752,977, 5,560,898 and 5,695,734. However, these carbon nanotube purifying methods must be performed at high temperature or high voltage, may require addition of metal catalysts, such as Ni, Fe, Co, Mo, or must use oxidizing agent or organic solvent. The purifying methods described all present cost and fabrication limitation disadvantages.

### SUMMARY

Accordingly, embodiments of the invention provide a method for purifying carbon nanomaterial.

In an embodiment of the invention, a method for purifying carbon nanomaterial comprises providing a carbon nanomaterial or a device substrate having a carbon nanomaterial. The carbon nanomaterial or the device substrate having a carbon nanomaterial is placed in a chamber. Ozone is introduced into the chamber at room temperature and atmospheric pressure to oxidize and remove impurities from the carbon nanomaterial.

### DESCRIPTION OF THE DRAWINGS

The embodiments can be more fully understood by reading the subsequent detailed description and examples with references made to the accompanying drawings, wherein:

FIG. 1 shows a process flow of a carbon nanotube purifying method of the present invention.

FIG. 2 is graph comparing electron field versus current density of CNT-FET specimens treated by the present invention and conventional methods.

### DETAILED DESCRIPTION

The present invention provides a method for purifying and cleaning carbon materials from many impurities, such as catalyst particles, amorphous carbon, graphite particles, coal ash and non-tube carbons, produced during fabrication.

The method for purifying and cleaning carbon materials of the present invention is suitable for carbon nanotubes, carbon nanoballs or carbon nanofibers. Carbon nanotubes comprise single-well carbon nanotubes (SWNTs) and/or multi-well carbon nanotubes (MWNTs). This method can further clean the surface of a device comprising carbon nanotubes, such as CNT-FET and can be used in semiconductor, photoelectrics, bio-technology and nanomaterials.

The purifying method of the present invention oxidizes impurities to simple molecules, such as CO2, R—COOH, in use of specific ozone concentration and treatment time at room temperature and atmospheric pressure. This method does not destroy carbon surface structure and requires no other chemical agents.

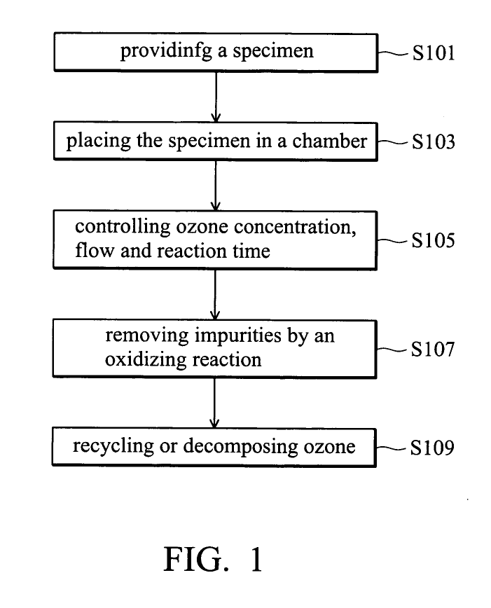

FIG. 1 shows a process flow of a carbon nanotube purifying method of the present invention. In step S101, a specimen comprising carbon nanomaterial is provided. In step S103, the specimen is placed in a chamber of anti-ozone materials, such as poly vinylidene fluoride (PVDF) or poly terafluoroethylene.

In step S105, ozone is fabricated by an onsite ozone producer utilizing high voltage electron field or UV radiation of a source gas comprising air, pure oxygen or a mixture of oxygen and nitrogen. The ozone concentration and flow and reaction time are controlled. In step S107, ozone is introduced into the chamber continuously at room temperature and atmospheric pressure to remove impurities by oxidization.

In step 109, ozone supply is terminated. After exhaust, the specimen is removed. The exhaust ozone can be recycled or decomposed by an ozone destructor, such as UV radiation lamp, such that there is no exhaust emission problem. The specimen is analyzed.

The present invention purifies carbon nanomaterials by the oxidization of ozone, and is harmless to the carbon nanomaterials.

According the invention, ozone concentration is about 0.15˜17 wt %, processing time is about 5˜120 seconds, and ozone flow is about 30˜120 liter/hour preferably.

The present invention provides a method for purifying carbon nanomaterials in which organic impurities are oxidized by ozone at room temperature and atmospheric pressure, without the presence of catalysts, acids or bases, organic solvents, or other chemicals. Unreacted ozone can be decomposed by an ozone destructor before exhaust. Accordingly, the present invention provides a simple purification process which is high-throughput and environmentally friendly.

### EXAMPLE

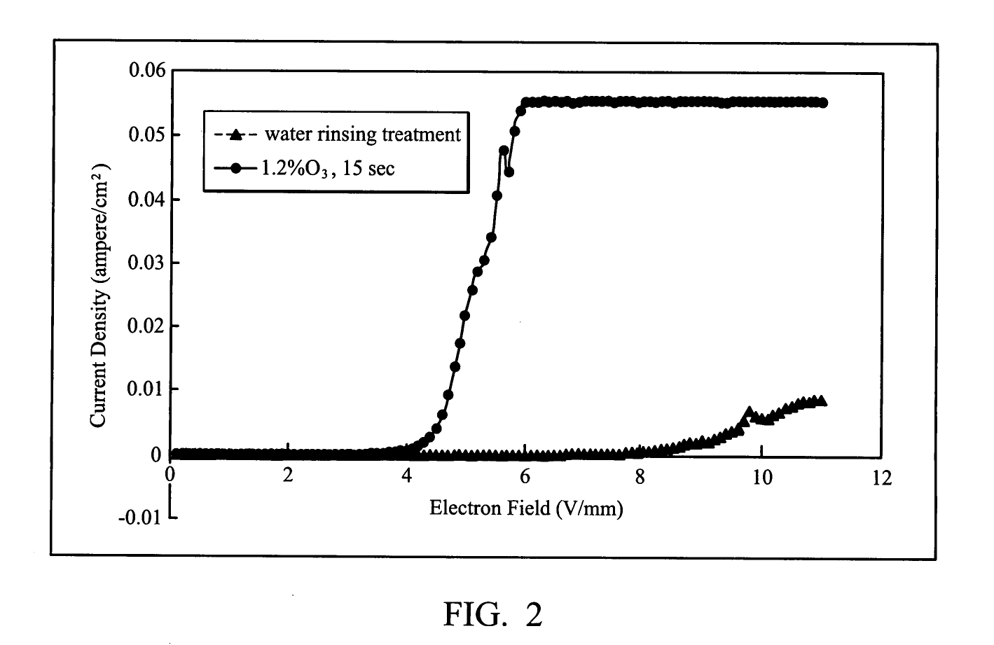

FIG. 2 is graph comparing electron field versus current density of CNT-FET specimens treated by the present invention and conventional methods. A CNT-FET specimen was formed by coating an Ag electrode on a glass substrate. Slurry comprising single-well carbon nanotubes was printed on the Ag electrode to form a 2*5 cm² specimen. Carbon nanotube cathode area comprises about ½ of the specimen.

The CNT-FET specimen was rinsed in water to remove impurities form the surface and dried at 105° C. for 20 minutes, generating a comparison sample.

A new sample was formed by placing the comparison sample in a 35 cm*35 cm*30 cm chamber to remove impurities with ozone at room temperature and atmospheric pressure. The ozone was formed from pure oxygen as a concentration about 1.2%. The flow rate of the ozone was about 90 liter/hour, and the processing time about 15 seconds. The result of the purified specimen is shown in FIG. 2.

FIG. 2 shows the current density (ampere/cm²) of two samples at 3V threshold voltage and various electron field (V/mm). This graph shows the specimen of the present method having a higher current than the conventional specimen.

While the invention has been described by way of Example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation to encompass all such modifications and similar arrangements.

What is claimed is:

1. A method for purifying carbon nanomaterial, comprising:
providing a carbon nanomaterial or a device substrate having a carbon nanomaterial;
placing the carbon nanomaterial or the device substrate in a chamber; and
introducing ozone into the chamber at room temperature and atmospheric pressure.

2. The method as claimed in claim 1, wherein the carbon nanomaterial comprises a carbon nanotube.

3. The method as claimed in claim 2, wherein the carbon nanotube has single-wall and/or multi-walls.

4. The method as claimed in claim 1, wherein the ozone is formed by high voltage electric field or UV radiation.

5. The method as claimed in claim 4, wherein the ozone is formed by a source gas comprising air, pure oxygen, or a mixture of oxygen and nitrogen.

6. The method as claimed in claim 1, wherein a mixing gas with an ozone content of about 0.15˜17% is introduced.

7. The method as claimed in claim 1, wherein the ozone is introduced into the chamber continuously.

8. The method as claimed in claim 6, wherein processing time of the oxidization is about 5˜120 seconds.
